(19) United States
(12) Patent Application Publication
(10) Pub. No.: US 2025/0282028 A1
(43) Pub. Date: Sep. 11, 2025

(54) QUCIK MULTI-FUNCTIONAL BENCH VISE

(71) Applicant: HUIJUAN LIU, Linyi (CN)

(72) Inventor: HUIJUAN LIU, Linyi (CN)

(21) Appl. No.: 18/609,614

(22) Filed: Mar. 19, 2024

(30) Foreign Application Priority Data
Mar. 7, 2024 (CN) 202420448918.1

(51) Int. Cl. B25B 1/02; B25B 1/10; B25B 1/20; B25B 1/22; B25B 1/24

(52) U.S. Cl. CPC B25B 1/02; B25B 1/103; B25B 1/20; B25B 1/22; B25B 1/2452; B25B 1/2484

(57) ABSTRACT

This application relates to the technical field of bench vise, and specifically, to a quick multi-functional bench vise, including: bench vise body; The movable vise assembly, which the movable vise assembly is slidably mounted on one side of the top of the bench vise body. By placing V-shaped limit blocks under the jaws of the bench vise body and the movable jaw assembly, users can easily grip round tubes in both horizontal and vertical orientations. This versatility makes the bench tiger pliers suitable for a broader range of applications, offering convenience and efficiency while enhancing its practicality and functionality.

### CROSS-REFERENCE TO RELATED APPLICATIONS

The application claims priority to Chinese patent application No. 202420448918.1, field on Mar. 7, 2024, the entire contents of which are incorporated herein by reference.

### TECHNICAL FIELD

This application relates to the technical field of bench vise, and specifically, to a quick multi-functional bench vise.

### BACKGROUND

“Bench Vise,” also known as “Vise” or “Bench Clamp” in English, is a universal fixture used for holding workpieces. It is mounted on a workbench to secure and stabilize the workpiece during machining processes. It is an essential tool in a workshop for metalworking tasks. The swiveling head of the vise allows the workpiece to be rotated into the desired working position.

The structure of a “Bench Vise” consists of a vise body, base, guide nut, screw, jaw body, and other components. The movable jaw body slides along the guide rails with the fixed jaw body through a sliding coordination. The screw is mounted on the movable jaw body and can rotate but not move axially. It coordinates with the screw nut installed inside the fixed jaw body. When the handle is turned to rotate the screw, it drives the movable jaw body to move axially relative to the fixed jaw body, performing the clamping or loosening function.

A spring, fixed on the screw with a retaining ring and a split pin, ensures that the movable jaw body promptly withdraws when the screw is loosened. Both the fixed and movable jaw bodies are equipped with steel jaws fixed with screws. The working surfaces of the jaws have intersecting patterns to prevent the workpiece from sliding after clamping. The jaws are hardened through heat treatment for better wear resistance.

The fixed jaw body is mounted on a swivel base, allowing it to rotate around the axis of the base. When turned to the desired direction, pulling the clamping handle tightens the clamping screw, securing the fixed jaw body. The swivel base has three bolt holes for securing it to the bench. However, existing bench vises have limited functionality. When clamping a round tube with the jaws, they can only provide longitudinal clamping. If attempting to clamp the tube horizontally, it is prone to slipping downward between the two jaws, resulting in poor practicality.

As an example of this, U.S. Pat. No. 11,872,672B2 discloses an Modular vise, the vise includes Modular design addresses the issue of the bench vise's single functionality by involving modularity.

However, this application not address the issue of the bench vise being limited to longitudinal clamping when gripping a round tube with its jaws. When attempting horizontal clamping, the round tube is susceptible to impact and may easily slip downward between the two jaws, posing practicality challenges.

Therefore, this application provides a solution to the above technical issues with a quick and versatile bench vise.

### SUMMARY

This application provides a quick and versatile bench vise that addresses the limitations of existing models. Unlike conventional bench vises that can only provide longitudinal clamping when gripping a round tube with their jaws, this new design enhances practicality by preventing the round tube from easily slipping downward between the two jaws when subjected to lateral pressure during horizontal clamping.

The quick and versatile bench vise in this application includes an bench vise body, movable vise assembly, assembly holes, and jaws;

Said movable vise assembly is slidably installed on one side of the top of the bench vise body, while the other side of the top of the bench vise body is fixedly attached to a fixed table. The bottom of the bench vise body is securely mounted with a connecting base, and at the bottom of the connecting base, there is a fixed connection with a supporting base. The top of the supporting base has bolt slots on both sides.

Said Assembly holes are located in the middle of the bottom of the supporting base.

Said jaws, consisting of two pieces, are each securely connected to the surface of the connector and the fixed table on one side through bolts. On the other side of the surfaces of the connector and the fixed table, V-shaped limiting blocks are fixedly installed.

In some embodiments, inside the bench vise body, a threaded pillar is rotationally mounted, with one end of the threaded pillar being fixedly connected to a rotating screw. Inside the rotating screw, one side is slidably fitted with a rotating rod.

In some embodiments, one side of the inside of the connector is equipped with a locking button.

In some embodiments, the interior of the bolt slot is rotationally connected to a bolt, with the bottom end of the bolt fixedly connected to a limit slide block. The bottom of the external surface of the bolt is fitted with a rotating base, while the top of the external surface of the bolt is equipped with a locking nut. Inside the locking nut, a locking rod is slidably installed.

In some embodiments, one side of the bottom of the rotating base, a limit groove is opened, while the middle of the top of the rotating base has a through-hole. Three sides of the external surface of the rotating base are fixedly equipped with fixed blocks, and the middle of the top of each fixed block has a bolt hole. On one side of the top of the rotating base, there is an installation groove, and both sides at the top of the installation groove have screw holes.

In some embodiments, the interior of the installation groove is securely fitted with a C-shaped clamping piece using screws. The C-shaped clamping piece has a threaded hole on one side of its surface.

In some embodiments, the locking button includes a pressing block, with a groove opened on one side of the bottom of the pressing block. Inside the opened groove, a threaded surface is set on one side. One side of the surface of the pressing block is equipped with a spring, and the other side has a fixed installation of a compression plate.

According to the foregoing embodiment, because the placing V-shaped limiting blocks underneath the jaws of the bench vise body and movable vise assembly, users can easily grip round tubes both longitudinally and laterally, maintaining stability during workpiece processing. This allows for processing of various shapes such as round and square tubes. The top side of the movable jaw body features a bullhorn anvil, providing users with a platform for hammering. The anvil comes with a through-hole, facilitating the processing of elongated workpieces for bending and hammering. The bullhorn design allows for striking both round and arc shapes. The bench vise body's lower center is equipped with a connecting hole, and on both sides, there are U-shaped notches. This enables users to directly secure the bench vise to the workbench using two bolts. The bench vise can be applied in more scenarios, offering increased convenience and efficiency, thus enhancing its practicality and functionality.

### BRIEF DESCRIPTION OF DRAWINGS

FIG. 1 is a first schematic structural diagram of a quick multi-functional bench vise according to an embodiment;

FIG. 2 is a front view of mounting base according to FIG. 1;

FIG. 3 is an enlarged view of mark point A according to the FIG. 2;

FIG. 4 is a bottom view of support base according to FIG. 1

FIG. 5 is a second schematic structural diagram of a quick multi-functional bench vise according to an embodiment;

FIG. 6 is a schematic structural diagram of a movable vise assembly according to FIG. 5;

FIG. 7 is a third schematic structural diagram of a quick multi-functional bench vise according to an embodiment;

FIG. 8 is a bottom view of support rod according to the FIG. 7;

FIG. 9 is a front view of support rod according to FIG. 7; and

FIG. 10 is a schematic structural diagram of engagement device according to FIG. 3.

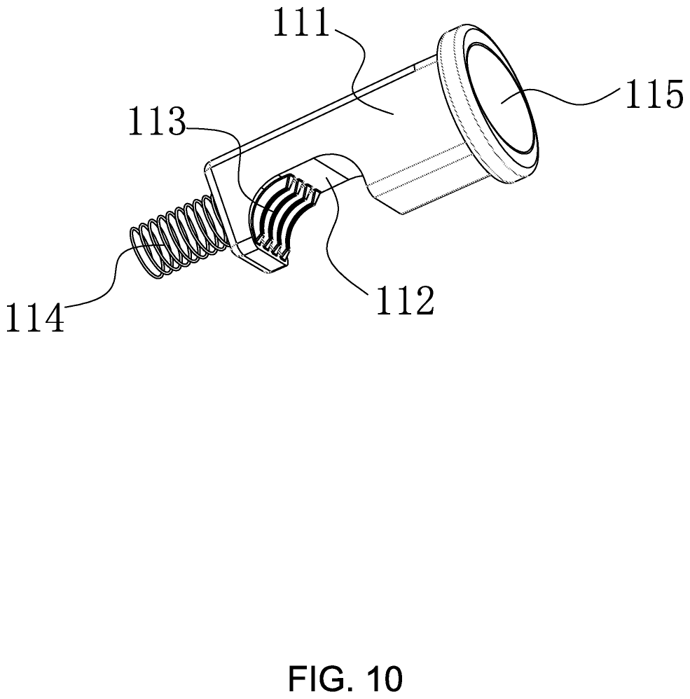

### DESCRIPTION OF EMBODIMENTS

This application is further described in detail below by using specific embodiments in conjunction with the accompanying drawings. Herein, associated similar element numbers are used for similar elements in different embodiments. In the following embodiments, many details are described to facilitate better understanding of this disclosure. However, those skilled in the art may readily understand that some features may be omitted in a different case, or may be replaced by another element, material, and method. In some cases, some operations related to this application are not shown or described in this specification, this is intended to prevent excessive descriptions from dominating a core part of this application, and for those skilled in the art, it is inessential to describe these related operations in detail, and they can fully understand the related operations based on the descriptions in this specification and general technical knowledge in the art.

In addition, features, operations, or characteristics described in this specification may be combined into various embodiments in any proper manner.

Serial numbers of components such as “first”, “second”, and the like herein are only used to distinguish between the described objects, and do not have any sequential or technical meaning. Unless otherwise specified, a “connection” and a “communication” mentioned in this application include both direct and indirect connections (communications).

### Embodiment 1

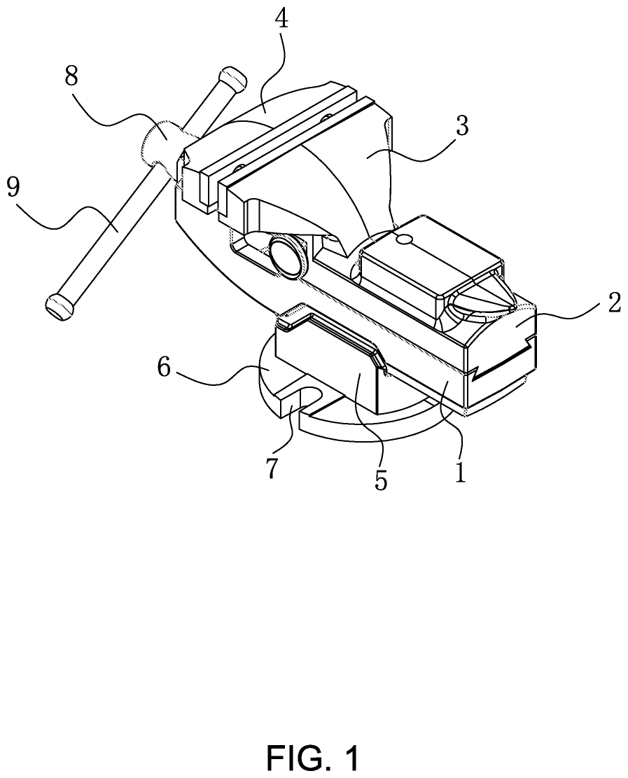

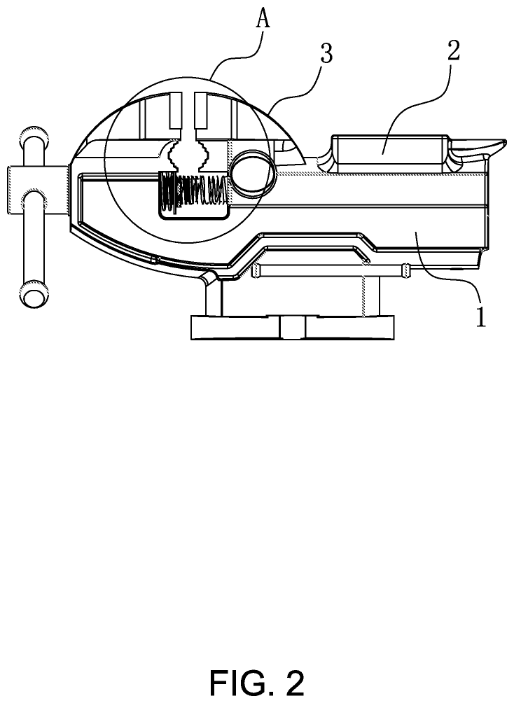

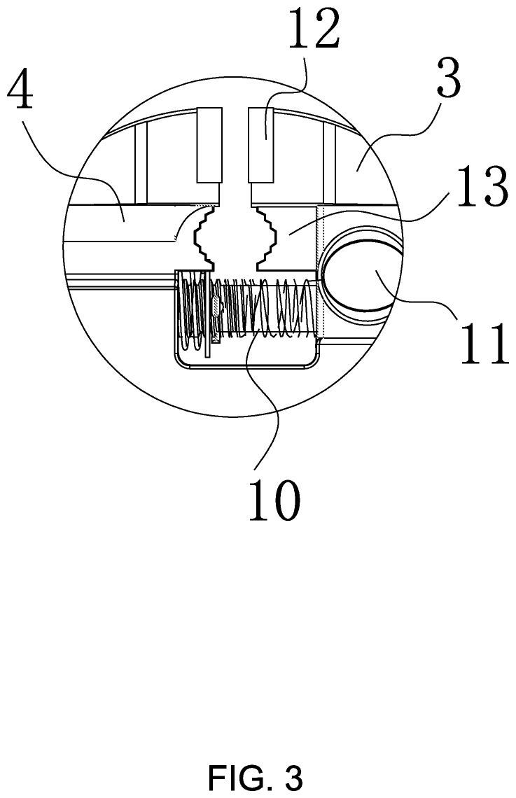

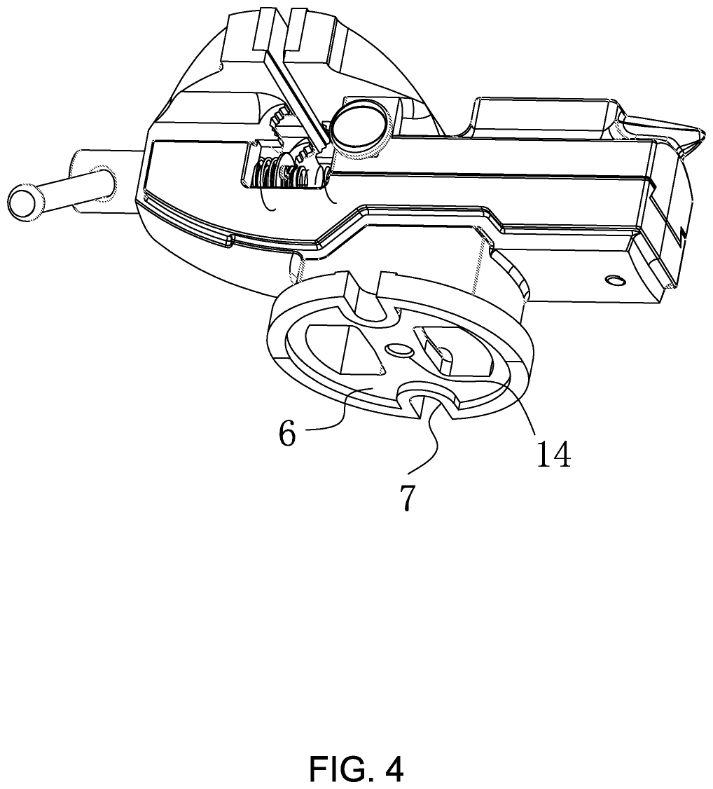

Referring to FIG. 1 to FIG. 4, a quick multi-functional bench vise in this application includes an bench vise body 1, movable vise assembly 2 is slidably mounted on one side of the top of bench vise body 1. On the other side of the top of bench vise body 1, there is a fixed table 4. The bottom of bench vise body 1 is securely mounted with a connecting base 5, and the bottom of connecting base 5 is fixedly connected to a supporting base 6. the top sides of the supporting base 6 are equipped with bolt slots 7.

Assembly holes 14 is located in the middle of the bottom of the supporting base 6.

Jaws 12, consisting of two pieces, are each fixedly connected to one side of the surfaces of connector 3 and fixed table 4 through bolts. On the other side of the surfaces of connector 3 and fixed table 4, V-shaped limiting blocks 13 are fixedly installed.

Inside the bench vise body 1, a threaded pillar 10 is rotationally mounted, with one end of the threaded pillar 10 being fixedly connected to a rotating screw 8. Inside the rotating screw 8, one side is slidably fitted with a rotating rod 9.

One side of the interior of the connector 3 is equipped with a locking button 11.

The locking button 11 comprises a pressing block 111. One side of the bottom of the pressing block 111 has an opened groove 112, and the inside of the opened groove 112 has a threaded surface 113. One side of the surface of the pressing block 111 has a spring 114, and the other side of the surface has a fixed installation of a compression plate 115.

On the top right side of the movable vise assembly 2, there is an iron platform for convenient hammering of the workpiece. The top right side of the movable vise assembly 2 is designed with a bullhorn shape, allowing for striking both round and arc shapes.

The top center of the bench vise body features a groove, and the bottom center of the movable vise assembly 2 is securely connected to a slider. The slider is fitted on the external surface of the threaded pillar 10. A cavity is opened on the front side of the movable vise assembly 2, with the rear end of the spring 114 connected to the cavity. The front end of the spring 114 is connected to the pressing block 111. The restoring force of the spring 114 drives the pressing block 111, causing the threaded surface 113 to engage with the threads of the threaded pillar 10. This allows the operator to rotate the rotating rod 9, driving the rotation of the rotating screw 8 and threaded pillar 10. As the threaded pillar 10 rotates, its threaded surface 113 engages with the threads of the threaded pillar 10, causing the locking button 11 to drive the sliding movement of the movable vise assembly 2 at the top of the bench vise body.

The movable vise assembly 2 and connector 3 form an integral unit, while the bench vise body 1 and fixed table 4 form another integral unit. The movable assembly 3 can slide left and right on the surface of the bench vise body 1, allowing the fixed table 4 and connector 3 to move closer or farther apart, bringing the jaws 12 on that side closer together or farther apart. In the middle of the bottom right side of the bench vise body 1, there is an anti-loosening hole, providing a means of limiting between the bench vise body 1 and movable vise assembly 2. At the top of the movable vise assembly 2, there is a punching hole for punching purposes.

The interior of the movable vise assembly 2 features an installation groove. When the user needs to clamp an item, they press the locking button 11, causing the spring 114 to contract. After the contraction of the spring 114, the threaded surface 113 no longer engages with the threads on the external surface of the rotating screw 8. This allows the user to quickly slide the movable vise assembly 2, enabling rapid opening of the movable vise assembly 2 and bench vise body 1 to the desired position. Underneath the jaws of the bench vise body 1 and movable vise assembly 2, V-shaped limiting blocks 13 are respectively placed, allowing users to easily grip round tubes both longitudinally and laterally for stable workpiece processing. This enables processing of various shapes such as round and square tubes. On one side of the top of the movable vise assembly 2, there is a bullhorn anvil, providing a platform for hammering. The anvil comes with a through-hole, facilitating the processing of elongated workpieces for bending and hammering. The bullhorn design allows for striking both round and arc shapes. In the center underneath the bench vise body 1, there is a connecting hole, and on both sides, there are U-shaped notches. This allows users to directly secure the bench vise to the workbench using two bolts.

In some embodiments, quick multi-functional bench vise will work as follow:

During operation, start by bringing the fixed table 4 and connector 3 closer together, where jaws 12 and V-shaped limiting blocks 13 are respectively positioned on that side. The two jaws 12 and two V-shaped limiting blocks 13 allow for both lateral and longitudinal clamping of round tubes.

The movable vise assembly 2 is made of iron material, and its top platform is designed for processing elongated workpieces, enabling bending and hammering. The bullhorn-shaped design allows for striking both round and arc shapes.

Because of the placing V-shaped limiting blocks 13 respectively under the jaws of the bench vise body 1 and movable vise assembly 2, users can easily clamp round tubes both laterally and longitudinally, maintaining stability during workpiece processing. This design is suitable for processing various shapes, such as round and square tubes. On one side of the top of the movable vise assembly 2, there is a bullhorn anvil, allowing users to hammer on the platform. The anvil comes with a through-hole, facilitating the processing of elongated workpieces for bending and hammering. The bullhorn design allows for striking both round and arc shapes. In the center underneath the bench vise body 1, there is a connecting hole, and on both sides, there are U-shaped notches. This allows users to directly secure the bench vise to the workbench using two bolts. This design makes the bench vise applicable to a wider range of scenarios, offering greater convenience and efficiency, thereby enhancing its practicality and functionality.

### Embodiment 2

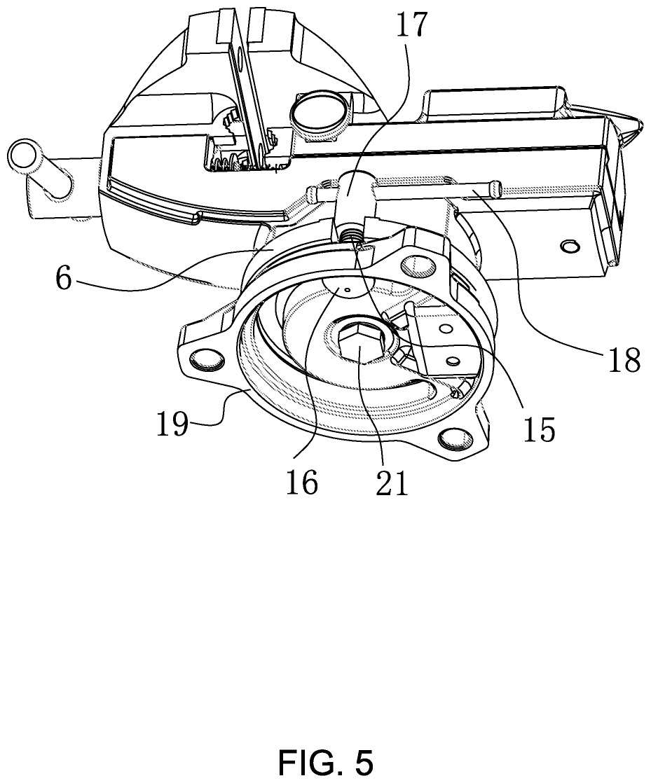

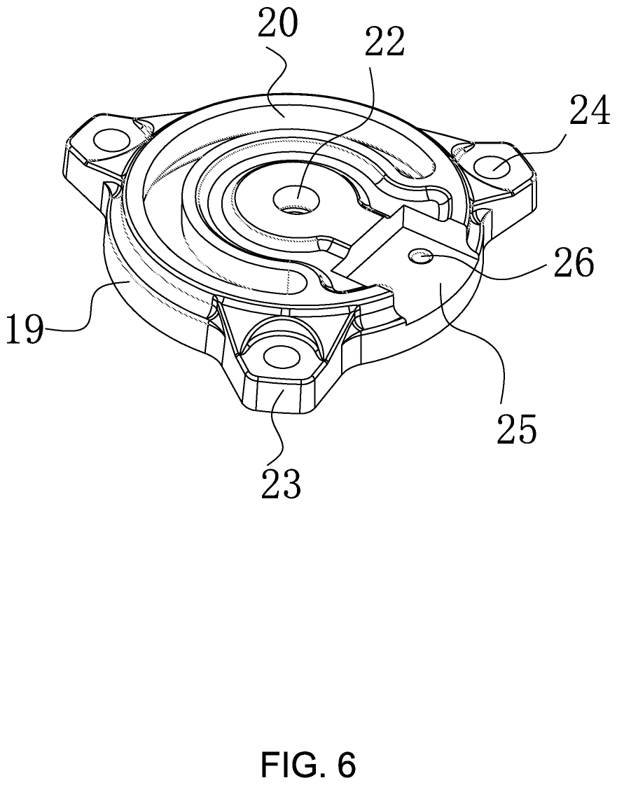

Referring to FIG. 5 and FIG. 6, This application provides another quick multi-functional bench vise, which the internal rotation of the bolt groove 7 is connected to a bolts 15. The bottom end of the bolts 15 is fixedly connected to a limit slide slider 16. The bottom of the external surface of the bolts 15 is equipped with a rotating base 19, while the top of the external surface of the bolts 15 is fitted with a locking nut 17. The internal part of the locking nut 17 has a sliding installation of a locking rod 18.

The bottom side of the rotating base 19 has a limit groove 20, and the middle of the top of the rotating base 19 has a through-hole 22. The external surface of the rotating base 19 is fixedly installed with fixed blocks 23 on all three sides. In the middle of the top of the fixed block 23, there is a bolt hole 24. On one side of the top of the rotating base 19, there is an installation groove 25, and on both sides of the top of the installation groove 25, there are screw holes 26.

The bolts 15 is slidably installed inside the limit groove 20, with the limit slide slider 16 wedged at the bottom of the limit groove 20. Rotating the locking rod 18 drives the rotation of the locking nut 17. As the locking nut 17 rotates, its threads engage with the bolts 15, causing it to move downward. The locking nut 17 presses against the top of the support base 6, thereby compressing the support base 6 and the rotating base 19 together.

The bottom end of the bolts 15 is fixedly installed with the limit slide slider 16. The bolts 15 can slide within the limit groove 20 for a range of two hundred and seventy degrees.

In this embodiments, quick multi-functional bench vise will work as follow:

During operation, start by loosening the step bolts 21, releasing the connection between the rotating base 19 and the support base 6. Operators can then rotate the support base 6, allowing the bolts 15 to slide within the limit groove 20 for a range of two hundred and seventy degrees, adjusting the processing angle of the support base 6.

After adjusting, tighten the step bolts 21 to securely limit the rotation of the rotating base 19 and support base 6. Once the step bolts 21 is removed from the rotating base 19 and support base 6, it becomes convenient to disassemble them.

By inserting through the bolt hole 24 and securing it to the work platform, the bench vise can be installed.

Because of the installing the rotating base 19, bolts 15, limit slide slider 16, locking nut 17, locking rod 18, limiting groove 20, step bolts 21, communication hole 22, fixed block 23, bolt hole 24, and installation groove 25 at the bottom of the support base 6, these components cooperate with each other. The rotating base 19 is mounted at the bottom of the support base 6 and on the surface of the processing platform. The operator can rotate the tiger pliers main body 270 degrees through the limiting groove 20, assemble the rotating base 19 and the support base 6 together with the step bolts 21, and achieve 360-degree rotation of the rotating base 19 when the step bolts 21 is loosened. When the step bolts 21 is tightened, the rotating base 19 cannot rotate freely, maintaining stable operation. The table tiger pliers can be stably installed on the processing platform and can also rotate to adjust the rotation angle, enhancing the functionality of the bench vise.

### Embodiment 3

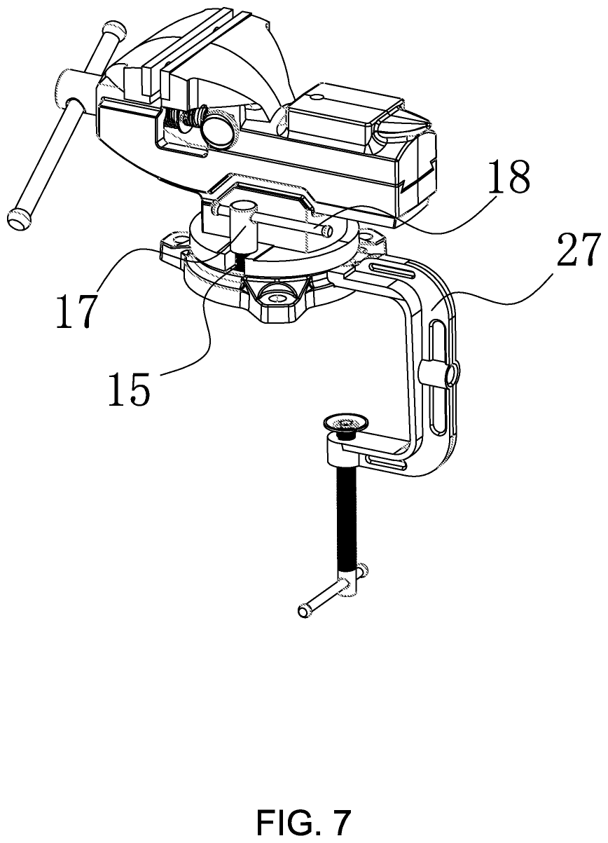

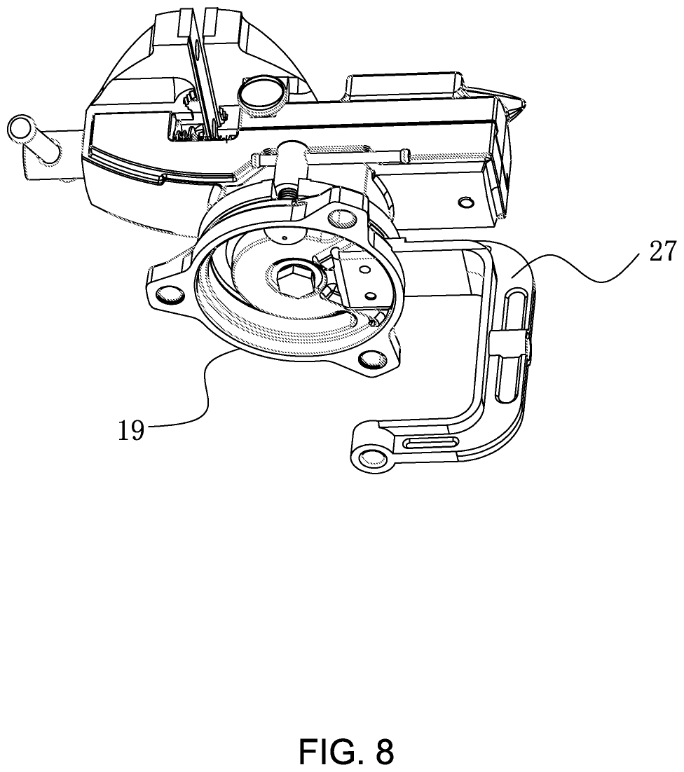

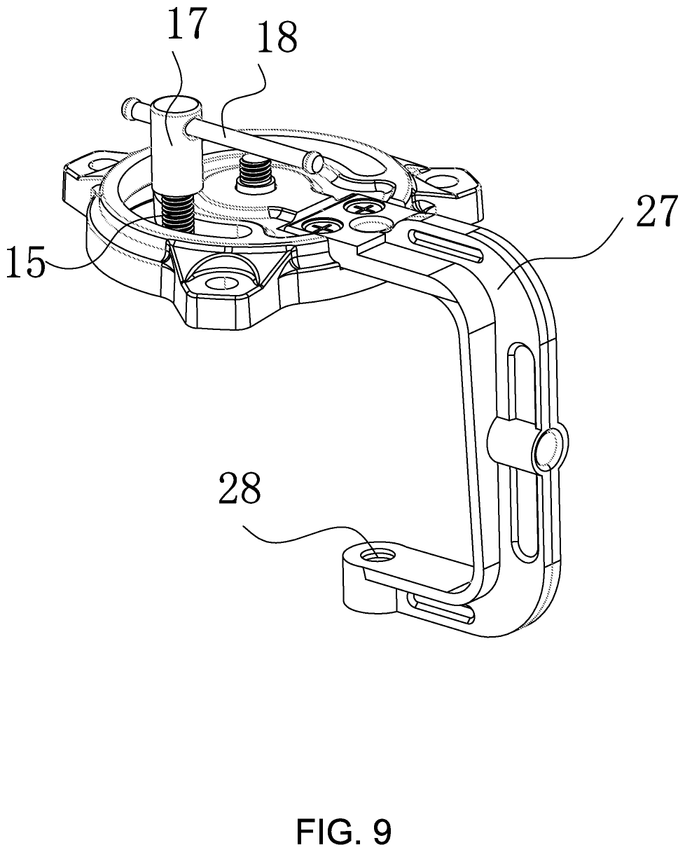

Referring to FIG. 7 to FIG. 9, This application provides yet another quick multi-functional bench vise, which The internal part of the installation groove 25 is fixedly installed with a C-shaped clamping piece 27 through screws. The C-shaped clamping piece 27 has a threaded hole 28 on one side of its surface.

The internal thread of the threaded hole 28 engages with a fixed screw. The top of the fixed screw is equipped with a clamping pad, ensuring that the clamping pad and the rotating base 19 are clamped on the upper and lower sides of the work platform.

In this embodiments, quick multi-functional bench vise will work as follow:

During operation, begin by attaching the C-shaped clamping piece 27 inside the installation groove 25 using screws, thereby assembling the rotating base 19 with the C-shaped clamping piece 27. Install a fixed screw into the internal thread of the threaded hole 28, allowing the fixed screw's thread to engage with the threaded hole 28, securing the rotating base 19 to the bottom of the work platform.

Because of using screws to install the C-shaped clamping piece 27 inside the installation groove 25, the rotating base 19 and the C-shaped clamping piece 27 are assembled together. Insert a fixed screw into the internal thread of the threaded hole 28, thus supporting the rotating base 19 on the work platform. This device has a simple structure and strong practicality, allowing for the adjustment of the installation height of the bench vise according to the operating height, thereby enhancing its practicality.

This application is described above by using a specific example. This is only used to help understand this application instead of limiting this application. Those skilled in the art to which this application belongs can also make several simple deductions, deformations, or substitutions according to the concept of this application.

What is claimed is:

1. A quick multi-functional bench vise, comprising: an bench vise body, movable vise assembly, assembly holes, and jaws;
Movable vise assembly is slidably installed on one side of the top of the bench vise body, while the other side of the top of the bench vise body is fixedly attached to a fixed table. The bottom of the bench vise body is securely mounted with a connecting base, and at the bottom of the connecting base, there is a fixed connection with a supporting base. The top of the supporting base has bolt slots on both sides.
Assembly holes are located in the middle of the bottom of the supporting base.
Jaws, consisting of two pieces, are each securely connected to the surface of the connector and the fixed table on one side through bolts. On the other side of the surfaces of the connector and the fixed table, V-shaped limiting blocks are fixedly installed.

2. The quick multi-functional bench vise according to claim 1, wherein comprising the internal part of the bench vise body is rotationally mounted with a threaded pillar, and one end of the threaded pillar is fixedly connected to a rotating screw. The internal side of the rotating screw is slidably mounted with a rotating rod.

3. The quick multi-functional bench vise according to claim 1, wherein comprises one side of the internal part of the connector is equipped with a locking button.

4. The quick multi-functional bench vise according to claim 1, wherein comprises internal part of the bolt groove is rotatably connected to a bolt, with the bottom end of the bolt fixedly connected to a limit slider. The bottom of the bolt's outer surface is fitted with a rotating base, while the top of the bolt's outer surface is equipped with a locking nut. The internal part of the locking nut accommodates a locking rod for sliding.

5. The quick multi-functional bench vise according to claim 1, wherein comprises the bottom side of the rotating base is equipped with a limit groove, while the middle of the top side of the rotating base has a through hole. The three sides of the outer surface of the rotating base are fixedly equipped with fixed blocks, and the middle of the top of the fixed blocks has a bolt hole. One side of the top of the rotating base is designed with an installation groove, and the two sides of the installation groove have screw holes.

6. The quick multi-functional bench vise according to claim 5, wherein comprises the interior of the installation groove is fixedly equipped with a C-shaped clamping piece using screws. The C-shaped clamping piece has a surface with a threaded hole on one side.

7. The quick multi-functional bench vise according to claim 3, wherein comprises The locking button includes a compression block. The bottom side of the compression block has a groove, and the inner side of the groove has a threaded surface. The surface of the compression block has a spring on one side, and the other side of the compression block's surface is fixedly installed with a compression plate.
